(19) United States
(12) Patent Application Publication
(10) Pub. No.: US 2024/0094518 A1
(43) Pub. Date: Mar. 21, 2024

(54) MICROSCOPE FOR FLUORESCENCE LIGHT IMAGING

(71) Applicant: Leica Microsystems CMS GmbH, Wetzlar (DE)

(72) Inventors: Benjamin Deissler, Wetzlar (DE); Christian Schulz, Wetzlar (DE); Christian Schumann, Wetzlar (DE)

(21) Appl. No.: 17/947,257

(22) Filed: Sep. 19, 2022

(51) Int. Cl. G02B 21/16; G01N 21/64; G02B 21/08

(52) U.S. Cl. CPC G02B 21/16; G01N 21/6458; G02B 21/08

(57) ABSTRACT

A microscope for fluorescence light imaging includes an illumination device configured to direct excitation light along an excitation beam path into a sample, and a detection device configured to detect fluorescence light emanating from the sample along a detection beam path which is located in a same hemisphere relative to the sample as the excitation beam path, wherein the illumination device includes a light guiding system configured to guide the excitation light such that, in phase space defined by position and angle of a light beam, a support of the excitation beam path is disjunct from a support of the detection beam path, and wherein the detection device includes at least one emission filter configured to allow the fluorescence light propagating along the detection beam path to be detected for fluorescence light imaging while discarding light that is spectrally different from the fluorescence light.

### FIELD

The present invention relates to a microscope and a method for fluorescence light imaging of a sample.

### BACKGROUND

Over the past years, so-called multiplexed imaging systems have become available that allow fluorescence imaging of multiple fluorophores simultaneously or sequentially. Such multiplexed imaging systems are of particular relevance in scientific applications known informally as omics that relate to various disciplines in biology such as genomics, proteomics, and so forth. Specifically, there are microscope systems which are configured to investigate the spatial distribution and correlation of multiple (up to hundreds) target markers, such as proteins, in a sample. For these applications, it is desired to image as many markers as possible in a single imaging round, i.e. without additional biochemical manipulation.

A classic method for multiplexed imaging is the use of a dichroic mirror separating an excitation beam path from a detection beam path along which the fluorescence light emerges from the sample. A microscope system that includes a fixed dichroic mirror for this purpose is disclosed e.g. in EP 3 721 279 A1. Alternatively, a switchable dichroic mirror can be used, often in combination with an excitation filter and an emission filter that are combined in form of a filter cube.

A dichroic mirror as mentioned above is configured to reflect those wavelengths that are required for excitation while letting wavelength for emitted light passes through, or vice versa. Each of the excitation bands has a certain width in which no emitted light can be detected. As the number of excitation bands increases, the combined width of the emission wavelength bands will decrease correspondingly. Using a fixed dichroic mirror implies a maximum number of usable excitation wavelength bands. Furthermore, the flexibility with regards to additional wavelength selection using additional emission filters is reduced, since the dichroic mirror already blocks a large wavelength range due to the excitation bands. This is particularly disadvantageous for multiplexed imaging as the number of fluorescent labels increases.

Alternatively, as mentioned above, switchable dichroic filters can be used, often integrated into filter cubes. However, the use of switchable dichroic filters requires a movable filter changer such as a filter turret with precise mechanical tolerancing to ensure the same deflection angle when operating with the different filters. In addition, the need for switching large optical components such as dichroic filters renders such a solution slow and costly.

Another method for multiplexed imaging is to use transmitted light illumination for fluorescence excitation such as described e.g. in the document U.S. Pat. No. 7,564,623 B2. Here, the excitation light illuminates the sample from a side opposite to the side on which the emitted fluorescence light is detected. Such a system may also be configured to shape the excitation light e.g. into a hollow light cone as described in the aforementioned document.

However, transmitted light illumination requires an additional beam path located on the opposite side of the sample. Therefore, such a system becomes large and bulky. In addition, since a significant amount of excitation light can enter into the detection beam path, the emission filters used for such a system must have a much higher extinction than in case of epifluorescence excitation. Thus, complicated coating designs are required causing high costs.

### SUMMARY

In an embodiment, the present disclosure provides a microscope for fluorescence light imaging, comprising an illumination device configured to direct excitation light along an excitation beam path into a sample, and a detection device configured to detect fluorescence light emanating from the sample along a detection beam path which is located in a same hemisphere relative to the sample as the excitation beam path, wherein the illumination device comprises a light guiding system configured to guide the excitation light such that, in phase space defined by position and angle of a light beam, a support of the excitation beam path is disjunct from a support of the detection beam path, and wherein the detection device comprises at least one emission filter configured to allow the fluorescence light propagating along the detection beam path to be detected for fluorescence light imaging while discarding light that is spectrally different from the fluorescence light.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of a fluorescence microscope according to an embodiment;

FIG. 2 is a diagram illustrating a separation between fluorescence excitation and fluorescence detection based on a phase space representation at a position of a sample;

FIG. 3 is a diagram illustrating the separation between fluorescence excitation and fluorescence detection based on the phase space representation at a back focal plane of an objective;

FIG. 4 is a schematic view of the fluorescence microscope according to an embodiment including a multispectral detector system;

FIG. 5 is a schematic view of a beam shaping unit configured to shape excitation light into an annular light distribution;

FIG. 6 is a schematic view of the beam shaping unit according to an embodiment;

FIG. 7 is a schematic view of the beam shaping unit according to an embodiment;

FIG. 8 is a schematic view of the beam shaping unit according to an embodiment;

FIG. 9 is a schematic view of the beam shaping unit according to an embodiment;

FIG. 10 is a schematic view of the beam shaping unit according to an embodiment;

FIG. 11 is a flow diagram of a method for fluorescence light imaging according to an embodiment;

FIG. 12 is an example of an image obtained with an emission filter; and

FIG. 13 is an example of an image obtained without an emission filter.

### DETAILED DESCRIPTION

In an embodiment, the present invention provides a microscope and a method that enable fluorescence light imaging while flexibly using a wide range of wavelengths for detection based on a simple and cost-effective configuration.

In an embodiment, a microscope for fluorescence light imaging comprises an illumination device configured to direct excitation light along an excitation beam path to a sample, and a detection device configured to detect fluorescence light emanating from the sample along a detection beam path which is located in a same hemisphere relative to the sample as the excitation beam path. The illumination device comprises a light guiding system configured to guide the excitation light such that—in a phase space defined by position and angle of a light beam—a support of the excitation beam path is disjunct from a support of the detection beam path. The detection device comprises at least one emission filter configured to allow the fluorescence light propagating along the detection beam path to be detected for fluorescence light imaging while discarding or blocking light that is spectrally different from the fluorescence light.

The aforementioned feature that the excitation light is guided such that a support of the excitation light beam path is disjunct from a support of the detection beam path refers to phase space. A phase space approach that is used to describe properties of an optical system is explained e.g. in the article of D. Rausch and A. M. Herkommer, “Phase space approach to the use of integrator rods and optical arrays in illumination systems”, Adv. Opt. Techn., Vol. 1 (2012), pp. 69-78, DOI 10.1515/aot-2011-0002. According to this approach, the functionality of an optical illumination system can be illustrated simultaneously in angle and position. In particular, optical illumination elements will, in general, affect the spatial light distribution as well as the angular distribution of the interacting radiation field. Accordingly, the approach uses a representation of the optical system that allows the effect on beam angles and beam positions to be observed and illustrated simultaneously.

The phase space referred to herein defines a set of possible states, each state being defined by a position and an angle of a light beam within the optical system. Furthermore, a support of the excitation beam path or the detection beam path is understood to be a subset in phase space containing the elements (states) that are not mapped to zero. In other words, the respective support is a phase space region in which the light distribution—in the sense of a phase space density—is non-zero.

The reference to phase space is intended to express that the light guiding system serves to guide the excitation light in such a way that the excitation beam path is spatially separated from the detection beam path in this phase space. More specifically, the light guiding system might be configured to direct the excitation light to the sample from at least one angular direction that is disjunct from a solid angle defined by a numerical aperture of an objective of the detection device, wherein the numerical aperture of the objective determines the collection of fluorescence light emitted from the sample. This ensures that, apart from the sample itself, the excitation light does essentially not overlap with the fluorescent light. Consequently, no spectral separation of excitation light and fluorescence light is required in the detection beam path in which the fluorescence light propagates towards the detector.

Spatial separation of the beam paths for fluorescence excitation and emission, using only one hemisphere of the sample space for both illumination and detection, in particular allows the entire wavelength range to be used for detection without the need for one or more dichroic mirrors otherwise used in fluorescence imaging. Thus, especially in multiplex imaging, it is difficult to realize a satisfactory solution based on multiple dichroic mirrors, especially if multiple wavelength bands with sharp filter edges are to be provided. The provision of switchable mirrors is also fraught with difficulties, especially in terms of the accuracy of light guidance and also in terms of costs.

The proposed solution can be implemented e.g. by illuminating the sample at angles corresponding to larger numerical apertures than those used for detection. In case that the illumination is realized with a rotationally symmetric angular distribution, the occurrence of shadowing can be prevented.

The detection device of the proposed configuration comprises at least one emission filter that allows the fluorescence light propagating along the detection beam path to be detected while it discards or blocks light that is spectrally different from the fluorescence light. In this respect, it should be noted that the above mentioned emission filter is to be distinguished from a dichroic beam splitter, which is used in a conventional fluorescence microscope to separate the detection light from the excitation light. In particular, as a result of the spatial separation of the excitation beam path and the detection beam path as disclosed herein, the emission filter is preferably located at a position outside the excitation beam path. In contrast, a typical dichroic filter in its usual use within a fluorescence microscope is located in a part of the beam path in which both excitation light and fluorescence light propagate.

The use of one or more emission filters in the proposed geometry allows flexibility in the choice of excitation wavelengths. For example, a single light source with a broad spectrum may be used in conjunction with switchable or tunable excitation filters. Alternatively, multiple excitation wavelengths may be used, or a tunable light source such as white light laser may be implemented. It may be particularly advantageous to use narrowband light sources such as laser sources in combination with narrowband emission filters in order to use a broad wavelength range for detection.

Preferably, the angle between the excitation beam path and the normal of the plane of detection is less than 87°, preferably less than 85° or less than 80°. In other words, the excitation light is preferably irradiated into the sample from a direction that is oblique to the optical axis of the detection device. In this respect, the microscope as proposed herein differs from conventional light sheet microscopes where the illumination light is irradiated into sample along a direction perpendicular to the optical axis of the detection device or from an oblique plane microscope, where the direction of illumination is within the cone of detection.

According to an embodiment, the light guiding system comprises a reflective assembly configured to reflect the excitation light onto the sample. Such a reflective assembly may be formed by a plurality of deflection mirrors which are configured to guide the excitation light as desired.

The detection device may comprise an objective including a lens system configured to collect the fluorescence light from the sample. Further, the light guiding system may be configured to guide the excitation light past the lens system of the objective onto the sample.

In an embodiment, the objective is formed by a dark-field objective which includes a light channel being part of the light guiding system and configured to guide the excitation light past the lens system of the objective onto the sample. The objective may be made from a single integrated dark-field assembly that combines the lens system and the light channel.

According to an embodiment, the detection device comprises a multispectral detector system configured to perform multispectral fluorescence light imaging. Combining the proposed configuration with a multispectral detector system is of particular advantage since such a combination does not require any dichroic mirrors separating the excitation beam path from the detection beam path, neither fixed nor switchable. This enables an excellent flexibility in the choice of detection wavelength bands. For multispectral imaging, it is often advantageous to have multiple imaging channels, i.e. combinations of excitation wavelength bands and detection wavelength bands. Using these channels, the abundances of the target markers can then be recovered by spectral unmixing techniques. The flexibility in the choice of detection wavelength bands can be utilized by choosing switchable or tunable emission filters. For example, narrowband notch filters can be used as emission filters when using narrowband light sources, leaving a broad wavelength range for detection of emitted fluorescence light.

Preferably, the multispectral detector system comprises a plurality of light detectors, each light detector being configured to detect one of the different spectral components comprising essentially one single wavelength or a wavelength band of the fluorescence light. The use of multiple detectors allows the detection of multiple wavelengths and/or wavelength bands simultaneously which decreases the time that is required to capture a plurality of imaging channels. Such a multispectral detector can be formed e.g. by a multi-camera detector, a spectral confocal detector or any other tunable detector. To use the full flexibility offered by the proposed configuration, such a multispectral detector system may also feature tunable detection wavelength bands.

According to an embodiment, the detection device comprises a plurality of spectral beam splitters, each beam splitter being configured to direct at least one of the different spectral components of the fluorescence light to an associated one of the light detectors.

Preferably, the excitation beam path is free of a dichroic beam splitter for separating the fluorescence light from the excitation light. A dichroic beam splitter (which is sometimes also referred as a main beam splitter) in the sense of this document in particular might be an optical element being configured to separate light from the excitation beam path from the light of the detection beam path.

According to an embodiment, the at least one emission filter is configured to be selectively inserted into and removed from the detection beam path. Such a setup is well suited for selectively operating the microscope with standard non-fluorescent dark field imaging as well. Thus, fluorescence emission filter can be simply replaced by a filter that transmits the excitation wavelengths, or the fluorescence emission can even be removed entirely, as required.

Preferably, the illumination device comprises a single broadband excitation light source and/or a plurality of narrowband excitation light sources.

The light guiding system may comprise a beam shaping unit configured to shape the excitation light into an annular light distribution around the optical axis of the detection device which might be configured to generate an essentially uniform annular light distribution in at least one of a radial direction and a circumferential direction in the illuminated object plane. For example, such a beam shaping unit may use one or more axicon lenses, one or more cone shaped mirrors, a diffractive optical element (DOE), or adaptive optics such as a spatial-light modulator (SLM), digital mirror device (DMD), or other combinations of refractive or diffractive beam shaping elements.

Preferably, the beam shaping unit comprises a light source configured to emit the excitation light, a collimator lens configured to collimate the emitted excitation light, and an annular stop configured to confine the excitation light to the annular light distribution.

The beam shaping unit might comprise a beam expanding system which is located between the collimator lens and the annular stop, the beam expanding system being configured to form a ring shaped light distribution from the collimated excitation light.

In an embodiment, the beam expanding system comprises two axicon lenses and a relay optical system that is configured to image an exit pupil of the illumination light after the second axicon onto the annular stop. Using such a relay optical system is advantageous in applications where the light source is formed by a relatively large light emitting surface.

Preferably, the beam shaping unit contains at least one of an axicon lens, a cone shaped mirror, a diffractive optical element, a spatial light modulator, or a digital mirror device.

According to an aspect, a method for fluorescence light imaging of a sample is provided. The method comprises the steps of directing excitation light along an excitation beam path into the sample, and detecting fluorescence light emanating from the sample along a detection beam path which is located in a same hemisphere relative to the sample as the excitation beam path. The excitation light is guided such that—in phase space defined by position and angle of a light beam—a support of the excitation beam path is disjunct from a support of the detection beam path. At least one emission filter is used to allow the fluorescence light propagating along the detection beam path to be detected for fluorescence light imaging while discarding light that is spectrally different from the fluorescence light. This method might be carried out by the microscope described above.

According to an embodiment, a plurality of different spectral components of the fluorescence light emanating from spectrally distinct fluorescent labels are detected using a multispectral detector system, wherein abundances of the spectrally distinct fluorescent labels are determined based on spectral unmixing of the different spectral components.

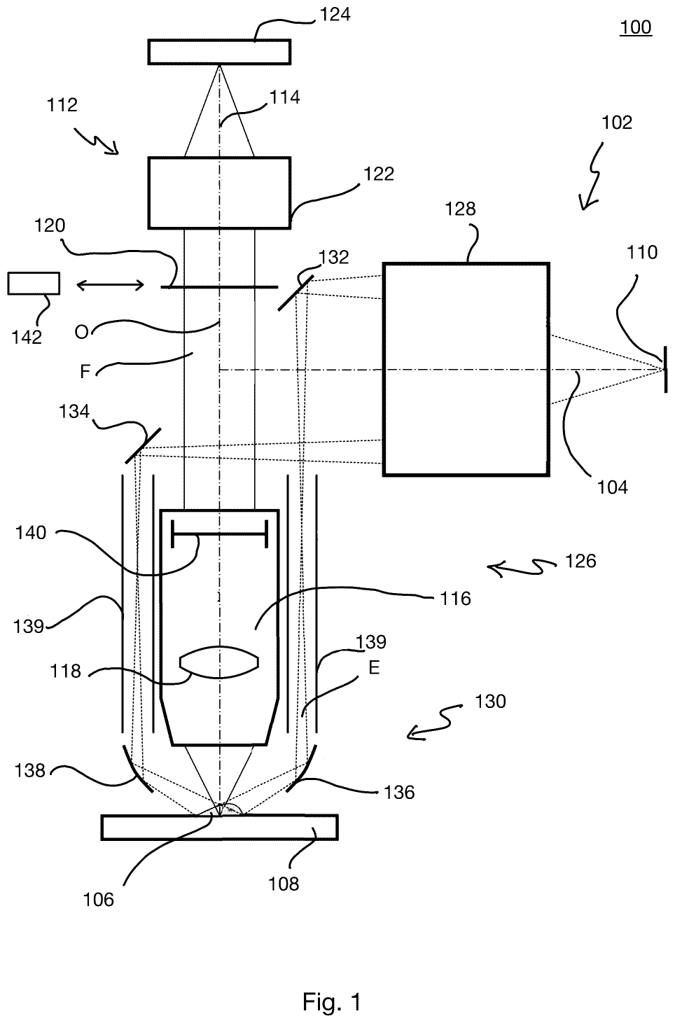

FIG. 1 is a schematic view showing a microscope 100 according to an embodiment. The microscope 100 is configured to perform fluorescence light imaging and is therefore referred to herein as a fluorescence microscope. More specifically, the fluorescence microscope 100 is configured to use one hemisphere (an upper hemisphere in the example of FIG. 1, in particular above the upper surface of the sample carrier 108) for both excitation and detection.

It is to be noted that FIG. 1 shows only those components of the fluorescence microscope 100 which are helpful to understand the operating principle of the solution presented herein. Needless to say, that the fluorescence microscope 100 may include additional components not explicitly shown in the diagram of FIG. 1.

The fluorescence microscope 100 includes an illumination device, generally denoted by reference sign 102 in FIG. 1, configured to direct excitation light E along an excitation beam path 104 onto a sample 106 disposed on a sample carrier 108. The illumination device 102 may comprise a single light source 110 as shown in FIG. 1. The light source 110 may be configured to emit a broad spectrum of excitation wavelengths from which one or more wavelengths can be selected using one or more excitation filters. To this end, the excitation filters located downstream of the light source 110 may be switchable or tunable in terms of excitation wavelengths. Instead of one broadband light source, several narrowband light sources, in particular laser sources, can be used. Furthermore, a tunable light source, such as a white-light laser, can be provided which makes it possible to adjust a wavelength of the emitted excitation light E as desired. The wavelength of the excitation light E is selected to excite fluorophores present in the sample 106 to emit fluorescent light F that is subsequently detected for fluorescence imaging.

The microscope 100 further comprises a detection device that is generally denoted by reference sign 112 in FIG. 1. The detection device 112 is configured to detect fluorescence light F emanating from the sample 106 along a detection beam path 114. As can be seen in FIG. 1, the overall optical system of the fluorescence microscope 100 is arranged such that the detection beam path 114 is located in a same hemisphere relative to the sample 106 as the excitation beam path 104. The detection device 112 includes an objective 116 which faces the sample 106. The objective 116 comprises a lens system 118 that is shown merely schematically as a single lens in FIG. 1. Needless to say that the lens system 118 may comprise a plurality of lens elements that are configured to collect the fluorescence light F from the sample 106 for fluorescence imaging.

The detection device 112 further comprises a fluorescence emission filter 120 and a tube lens 122 that is arranged in this order downstream of the objective 116 with respect to the propagation of the fluorescence light F. The emission filter 120 has spectral filter characteristics adapted to the fluorophores located in the sample 106 such that the emission filter 120 transmits the wavelength of the fluorescence light F along the detection beam path 114 while discarding or blocking light that is spectrally different from the fluorescence light F and/or scattered or reflected excitation light E. The tube lens 122 serves to focus the fluorescence light F propagating along the detection beam path 114 onto a light detector 124 to form an optical image thereon. In this way, a fluorescence image is generated based on the fluorescence light F that is emitted from the sample 106 and collected by the lens system 118 of the objective 116.

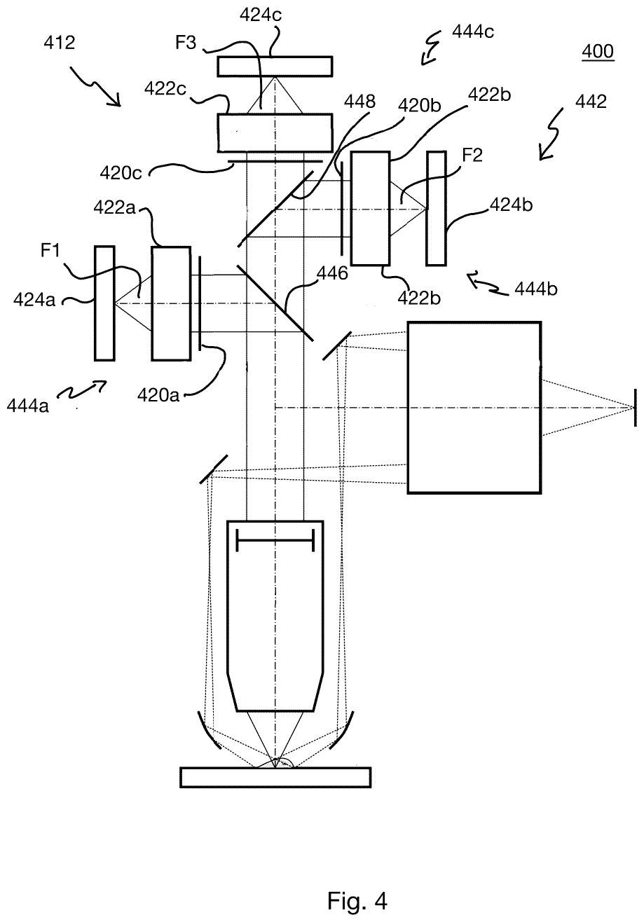

According to the embodiment shown in FIG. 1, the light detector 124 is a single sensor such as a CCD camera. However, as explained below with reference to FIG. 4, the detection device 112 may also comprise a multispectral detector system including a plurality of light detectors.

The illumination device 102 of the fluorescence microscope 100 includes a light guiding system that is generally denoted by reference sign 126 in FIG. 1. According to the present embodiment, the light guiding system 126 comprises a beam shaping unit 128 and a reflective assembly 130 including a plurality of deflection mirrors 132, 134, 136, 138. The deflection mirror indicated by reference numerals 132, 134 as well as 136, 138, respectively, might be a ring shaped mirror or an annular mirror. The beam shaping unit 128 and the reflective assembly 130 are arranged in this order downstream of the light source 110 along the excitation beam path 104.

The light guiding system 126 is configured to guide the excitation light E such that the excitation beam path 102 is spatially separated from the detection beam path 114. In particular, the guiding system 126 serves to keep the detection beam path 114 clear of the excitation E, thereby eliminating the need for a spectral beam splitting element such as a dichroic mirror otherwise used in conventional epifluorescence microscopes having a common objective for excitation and detection to separate the fluorescence light from the excitation light. As explained below, beam path separation is achieved even though the excitation beam path 104 and the detection beam path 114 are in the same hemisphere relative to the sample 106. Therefore, the fluorescence microscope 100 can be used like a conventional epifluorescence microscope.

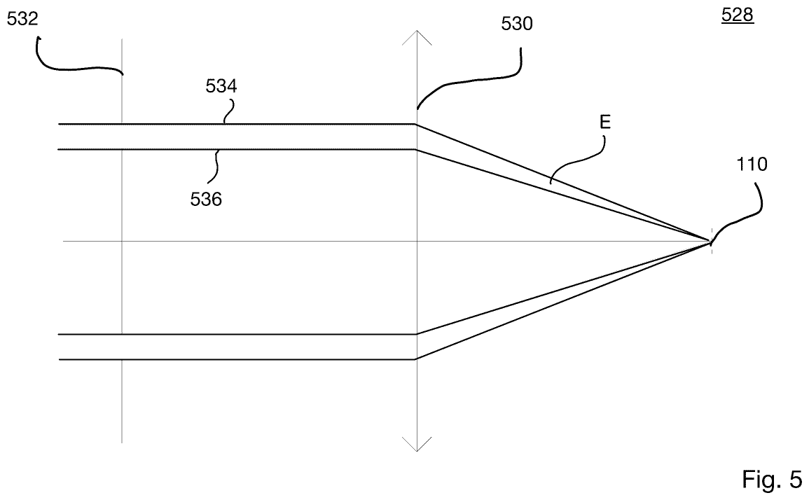

The beam shaping unit 128 is configured to shape the excitation light E emitted from the light source 110 as a divergent light bundle into an annular light distribution around the optical axis O of the objective 116. As explained below in more detail with reference to FIGS. 5 to 10, the beam shaping unit 128 is preferably designed to create a light distribution from the excitation light E that is rotationally symmetric about the optical axis O.

The reflective assembly 130 comprising the deflection mirrors 132 to 138 is adapted to guide the excitation light E emerging from the beam shaping unit 128 past the lens system 118 of the objective 116. Thereby, the excitation light E is guided in such a way that it is irradiated onto the sample 106 from the side at an oblique angle to the optical axis O. More specifically, an angle between the excitation beam path 104 of the excitation light E (more specifically a central axis thereof) and the optical axis O, that is coincident with a normal to a detection plane formed by a focus plane of the objective 116, may be less than 87°, preferably less than 85° or less than 80°. In this regard, it should be noted that FIG. 1 represents a cross-sectional view from which it is not immediately apparent that the excitation light E irradiated onto the sample 106 is actually a rotationally symmetric light distribution about the optical axis O in this particular embodiment. Accordingly, the deflection mirrors 132 to 138 are formed by optical elements that are correspondingly rotationally symmetric in shape, which allows the rotationally symmetric light distribution to be directed past the lens system 118 of the objective 116 into the sample 106.

The objective 116 may be formed, for example, by a dark-field objective which includes at least one light channel 138 being part of the light guiding system 126. According to the embodiment shown in FIG. 1, the light channel 138 is formed by an annular, preferably rotationally symmetric channel surrounding the lens system 118 which is centered on the optical axis O. Accordingly, the excitation light E deflected by the upstream deflection mirrors 132, 134 into the light channel 138 and propagating therein is guided past the lens system 118 to be incident on the downstream deflection mirrors 136, 138 which are arranged at an end portion of the objective 116 facing the sample 106. The deflecting mirrors 136, 138 are configured to direct the excitation light E propagating outside the lens system 118 at an oblique angle radially inward towards the optical axis O onto the sample 106. Thus, the excitation light E is guided to illuminate a target region of the sample 106 which coincides with the optical axis O to be imaged through the lens system 118 of the objective 116.

The objective 116 may be made from a single integrated dark-field assembly that combines the lens system 118 and the light channel 138 extending radially outside the lens system 118. As such, the objective 116 may also include the downstream deflection elements 136, 138. Moreover, unlike the configuration shown only as an example in FIG. 1, the upstream deflection elements 132, 134 may also be integrated into this assembly.

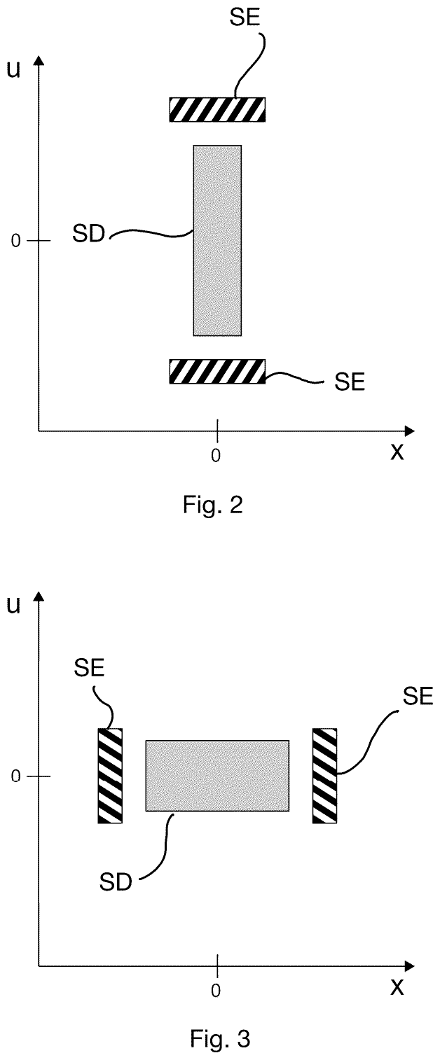

As described above, the guiding system 126 serves to spatially separate the excitation beam path 104 from the detection beam path 114, thereby eliminating the need for a dichroic beam splitter or for a main beam splitter for separating the fluorescence light F from the excitation light E. This spatial separation will be explained hereinafter using a phase space approach as illustrated FIGS. 2 and 3. As already mentioned, such a phase space approach is explained e.g. in the article of D. Rausch and A. M. Herkommer cited above.

FIGS. 2 and 3 are diagrams illustrating phase space representations at a position of the sample 106 and at a back focal plane 140 of the objective (see FIG. 1), respectively. Assumed that there is a source, or generally a radiation field, located at an origin of a Cartesian xyz-coordinate system with z representing the optical axis of the system, a phase space volume occupied by the source is defined by its spatial and angular extent and thus follows from an integration over the relevant area dA and solid angle dΩ. This quantity is called the etendue:

Etendue=n²∫∫cos(θ)dA dΩ

Here, n is the refractive index and θ is the angle between the normal of the differential area dA and the centroid of the differential solid angle dΩ.

In phase space, the etendue is conveniently expressed in terms of the projected solid angle du and dv, also containing the refractive index of the medium, wherein u is parallel to x and v is parallel to y. Thus, the etendue can be expressed as:

Etendue=∫∫dx dv du dv

The amount of flux, or optical power dip contained in a certain phase space volume defines the radiance distribution L of the source, i.e. the energetic weight within phase space:

$$L ( x , y , u , v ) = \frac{d ϕ}{\begin{matrix}dx & dy & du & dv\end{matrix}}$$

In general, the radiance distribution is a four-dimensional function of the phase space variables (x, y, u, v). As four dimensions are difficult to visualize, FIGS. 2 and 3 refer to a case where a light distribution is considered only in the xz-plane. Thus, the radiance distribution L is a function of x and u only. In this case, the angular variable u is associated with sin(θ) of a ray relative to the optical axis.

FIG. 2 illustrates the radiance distribution L as a function of (x, u) at a position where the sample 106 is located. The phase space representation of FIG. 2 shows that a support SE of the excitation beam path 104 is disjunct from a support SD of the detection beam path 114 at the position of the sample 106. In other words, at the position of the sample, the excitation beam path and the detection beam path overlap regarding their position in x, but differ in their angle, thus leading their supports to be disjunct in phase space. Furthermore, FIG. 3 illustrates the radiance distribution L as a function of (x, u) at a position of the back focal plane 140 of the objective 116. The phase space representation of FIG. 3 shows that the support SE of the excitation beam path 104 is disjunct from the support SD of the detection beam path 114 at the back focal plane 140 of the objective. In other words, in the back focal plane of the objective, the position in x differs while the beam angles overlap, thus leading their supports to be disjunct in phase space. Each of the supports SE, SD of the excitation and detection beam path 104, 114, respectively, represents a subset of coordinates (x, u) in phase space where the radiance distribution L is not mapped to zero.

As can be seen from FIGS. 2 and 3, the light guiding system 126 achieves an effective spatial separation—in the sense of phase space—of the excitation beam path 104 from the detection beam path 114.

Referring again to FIG. 1, the fluorescence microscope 100 may further be configured to allow the at least one emission filter 120 to be selectively inserted into and removed from the detection beam path 114. For this, the fluorescence microscope 100 may comprise a filter actor 142 that can be controlled to insert the emission filter 120 into the detection beam path 114 and to remove it therefrom. Based on such a configuration, the fluorescence microscope 100 is not restricted in its functionality to be operated exclusively in a fluorescence imaging mode as described above. Rather, the fluorescence microscope 100 may be used in a standard non-fluorescent dark field imaging mode as well. For this purpose, the emission filter 120 can simply be replaced with a filter that transmits the excitation wavelengths, or the emission filter 120 can even be removed without being replaced with another filter.

FIG. 4 is a schematic view showing a fluorescence microscope 400 representing another embodiment. The embodiment shown in FIG. 4 differs from the fluorescence microscope in FIG. 1 only with respect to the detector system used for fluorescence imaging. Other than the detector system, the fluorescence microscope 400 of FIG. 4 remains unchanged compared to the embodiment of FIG. 1. Thus, microscope components present in both embodiments will not be described again here.

In the embodiment of FIG. 1, a single sensor is used in form of the light detector 124. In contrast, a detection device 412 of the fluorescence microscope 400 shown in FIG. 4 comprises a multispectral detector system 442 which is configured to perform multispectral fluorescence light imaging. Just as an example, the multispectral detector system 442 may provide three different color channels 444a, 444b, 444c, each color channel including an emission filter 420a, 420b, 420c, a tube lens 422a, 422b, 422c, and a light detector 424a, 424b, 424c. The different colors assigned to the color channels 444a, 444b, 444c are determined by different spectral characteristics of the emission filters 420a, 420b, 420c.

In the example of FIG. 4, the detection device 412 includes two spectral beam splitters 446, 448 by which different spectral components of the fluorescence light F are sequentially distributed into the different color channels 444a, 444b, 444c. More specifically, the beam splitter 446 reflects a first spectral component F1 of the fluorescence light F into the first color channel 444a while transmitting the remaining fluorescence light towards the beam splitter 448. Subsequently, the beam splitter 448 reflects a second spectral component F2 that has been transmitted by the beam splitter 446 as a second spectral component F2 into the second color channel 444b while transmitting the remaining fluorescence light as a third spectral component F3 into the third color channel 444c. As a result, the first light detector 424a detects the first spectral component F1 included in the fluorescence light F emanating from the sample 106. Likewise, the second light detector 424b detects the second spectral component F2 of the fluorescence light F, and the third light detector 424c detects the third spectral component F3 of the fluorescence light F.

Hereinafter, specific embodiments of the beam shaping unit 128 are described with reference to FIGS. 5 to 10.

FIG. 5 shows a beam shaping unit 528 which includes a collimator lens 530 and an annular stop 532 arranged in this order as seen from the light source 110 emitting the excitation light E. It is to be noted that the light source 110 may also be formed by a light emitting end of an optical fiber. The collimator lens 530 is configured to collimate the divergent light bundle emitted from the light source 110 while the annular stop 532 serves to confine the excitation light E to an annular light distribution defined by outer marginal rays 534 and inner marginal rays 536 having maximal and minimal radial distances, respectively, from the optical axis. Thus, a radial inner portion of the excitation light E is blocked by the annular stop 532 so that only a radial outer portion of the excitation light E is used to for excitation. The excitation light E formed into an annular light bundle is subsequently irradiated onto the sample 106 by means of the reflective assembly 130 as explained above with reference to FIGS. 1 and 4.

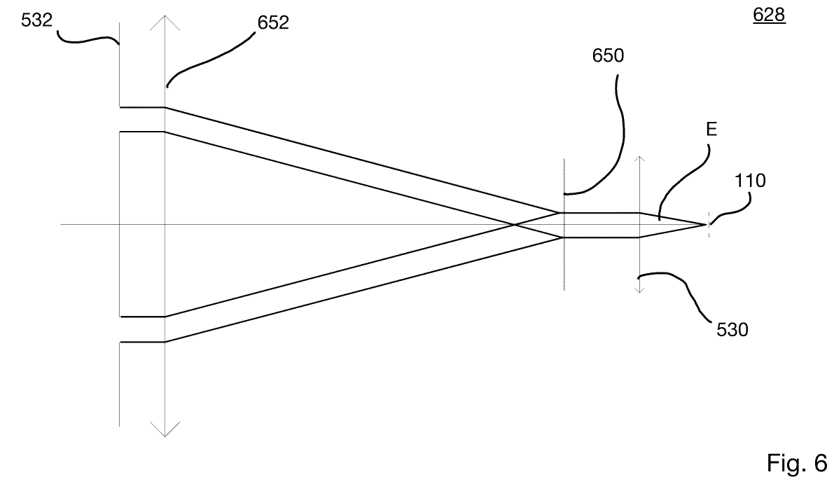

FIG. 6 shows a modified beam shaping unit 628 which includes a beam expanding system 650 and a lens 652 which are arranged in this order between the collimator lens 530 and the annular stop 532. The beam expanding system 650 may be formed from a spatial light modulator (SLM) or a diffractive optical element (DOE). In this configuration, the excitation light E is collimated by lens 530 onto the SLM or DOE which provides an artificial hologram causing the excitation light E to be diffracted into a conically divergent light distribution. Subsequently, the lens 652 collimates the divergent excitation light onto the annular stop 532. Even though it is not explicitly shown in FIG. 6, the excitation light E is focused by lens 652.

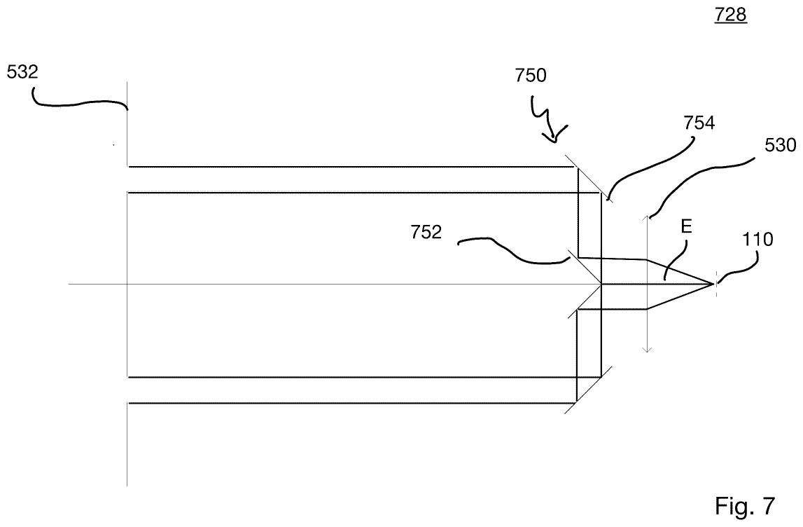

FIG. 7 shows a beam shaping unit 728 including a modified beam expanding system 750 which is formed by two coaxial conical mirrors 752, 754. It should be noted that FIG. 7 is a plane sectional view. Accordingly, each of the conical mirrors 752, 754 is annular in shape. In this configuration, the excitation light E is collimated onto the first conical mirror 752 which reflects the incident excitation light E radially outward onto the second conical mirror 754 to achieve beam expansion. Subsequently, the second conical mirror 754 reflects the expanded excitation light E into the annular stop 532.

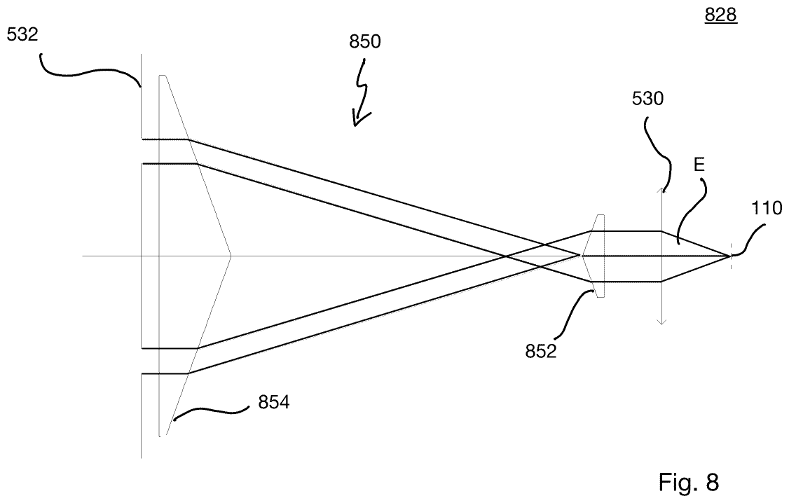

FIG. 8 shows a beam shaping unit 828 including a modified beam expanding system 850 which is formed by two axicon lenses 852, 854. In this configuration, the excitation light E is collimated by lens 530 onto the first axicon 852 which deflects the incident excitation light E to expand the excitation light E by creating a conically divergent light distribution. The second axicon 854 directs the expanded excitation light E onto the annular stop 532.

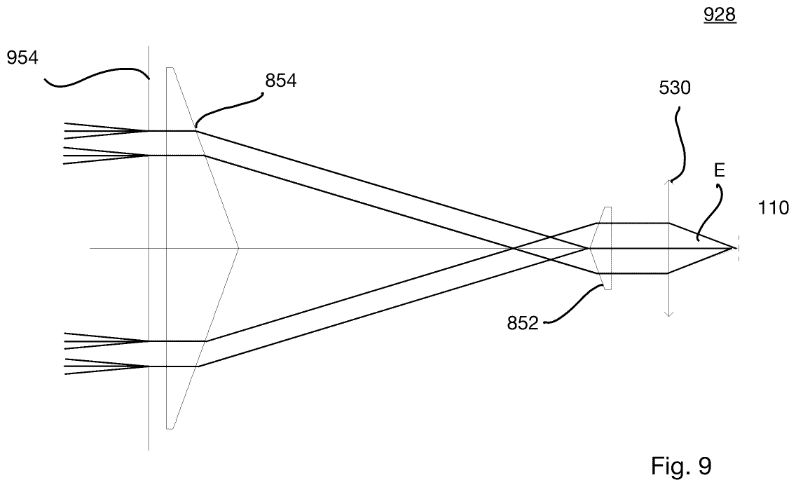

FIG. 9 shows a beam shaping unit 928 which is a modification of the embodiment according to FIG. 8. The beam shaping unit 928 is adapted to be used e.g. in applications where the light source 110 is formed by an end of a single mode optical fiber having a point-like shape and therefore small light emitting surface. In such a case, it may be difficult to achieve a sufficient field illumination by means of an axicon arrangement alone. Therefore, the beam shaping unit 928 includes a diffusing disk 954 downstream of the second axicon 854, either before or after the annular stop 532, in order improve the field illumination.

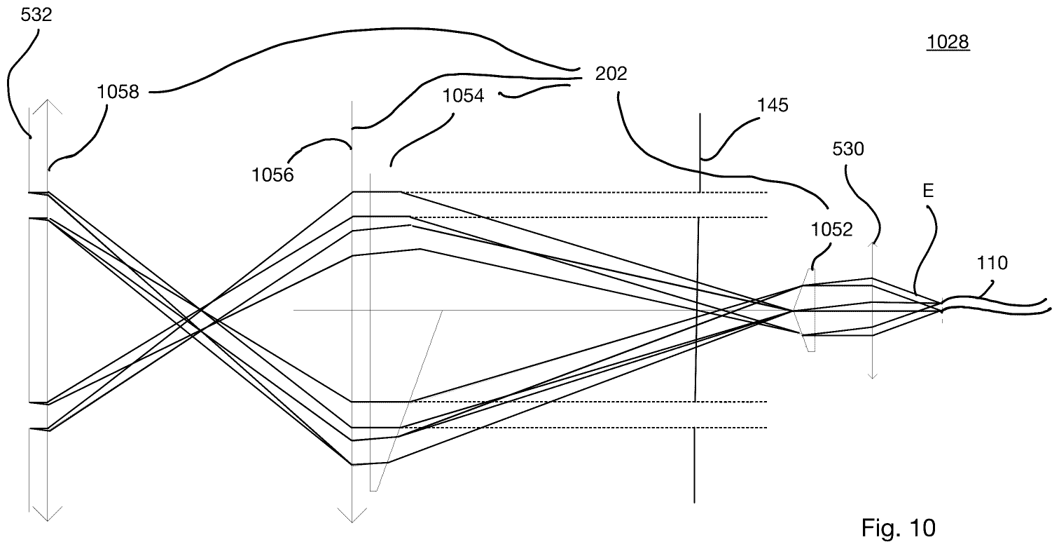

FIG. 10 shows a beam shaping unit 1028 including a modified beam expanding system which comprises a first axicon 1052, a second axicon 1054, a first lens 1056, and a second lens 1058. The elements 1052 to 1058 are arranged in this order as seen from the light source 110 between the collimator lens 530 and the annular stop 532. In this configuration, the lenses 1056, 1058 form a relay optical system that is configured to image an exit pupil 145 of the illumination light downstream the second axicon 1054 onto the annular stop 532. Due to the relay optical system, this embodiment is particularly suitable to provide homogeneous illumination in applications where the light source 110 is formed by a larger light emitting surface as illustrated by different light bundles emerging from spatially separated points of the light source 110 in FIG. 10.

As can be seen in FIGS. 5 to 10, each configuration of the beam shaping is designed to create a light distribution from the excitation light E that is rotationally symmetric about the optical axis.

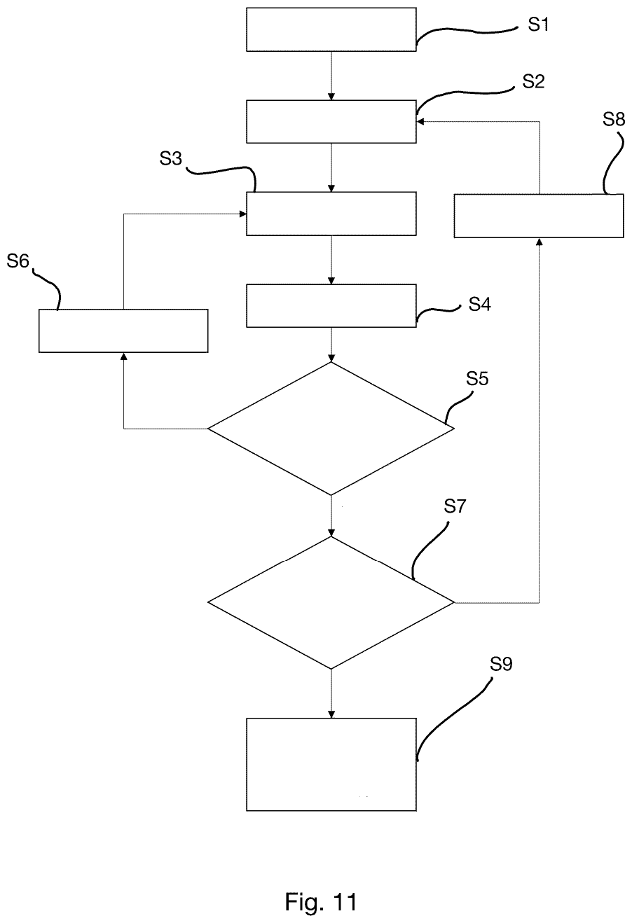

FIG. 11 is a flow diagram of a method for fluorescence light imaging according to an embodiment. This method serves to determine abundances of distinct fluorescent labels by means of a fluorescence microscope that includes a multispectral detector system as shown in FIG. 4.

In step S1, the fluorescence microscope is initialized.

Then, in step S2, a detection setting which might comprise a setting of a detection wavelength band m is set, where m denotes an integer counting the wavelength bands from m=1 to m=m_Max, m_Max being a maximum number of bands available. In other words, a loop at S2 starts with m=1 and is repeated by increasing the index m by 1 until m equals m_Max.

In step S3, an illumination setting which might comprise a setting of a illumination wavelength n is set, wherein n denotes an integer counting the illumination wavelengths from n=1 to n=n_Max, n_Max being a maximum number of wavelengths available. In other words, a loop at S3 starts with n=1 and is repeated by increasing the index n by 1 until n equals n_Max.

In step S4, an image I_m_n is captured, m and n denoting the aforementioned indices. Subsequently in step S5, it is determined whether or not n equals n_Max. If n equals n_Max in step S5, it is determined that all illumination wavelengths for the current detection band m are completed, and the control proceeds with step S7. If n is not equal to n_Max in step S5, it is determined that the illumination wavelengths for the current detection m are not yet completed, and the control proceeds to step S6 where the index n is incremented by 1 (n→n+1). The loop from S3 to S6 is repeated until it is determined that n equals n_Max.

In step S7, it is determined whether or not m equals m_Max. If m equals m_Max in step S7, it is determined that all detection wavelength bands are completed, and the control proceeds with step S9. If n is not equal to n_Max in step S7, it is determined that the detection wavelength bands not yet completed, and the control proceeds to step S8 where the index m is incremented by 1 (m→m+1). The loop from S2 to S8 is repeated until it is determined that m equals m_Max.

In step S9, a process for spectral unmixing is applied to all images I_m_n. Based on the result of this process, target abundances of the distinct fluorescent labels are calculated.

Thus, with regard to the configuration shown in FIG. 4, the method described above allows to determine abundances of spectrally distinct fluorescent labels based on spectral unmixing of the different spectral components F1, F2, F3 which are included in the fluorescence light F emerging from the sample 106.

As described above, the embodiment shown in FIG. 1 includes the filter actor 142 which allows the emission filter 120 to be selectively inserted into the detection beam 114 and to retract the emission filter 120 therefrom. Although not explicitly illustrated, a corresponding filter actor can be provided in each of the color channels 444a, 444b, 444c of the multispectral detector system 442 which is included in the fluorescence microscope 400 shown in FIG. 4.

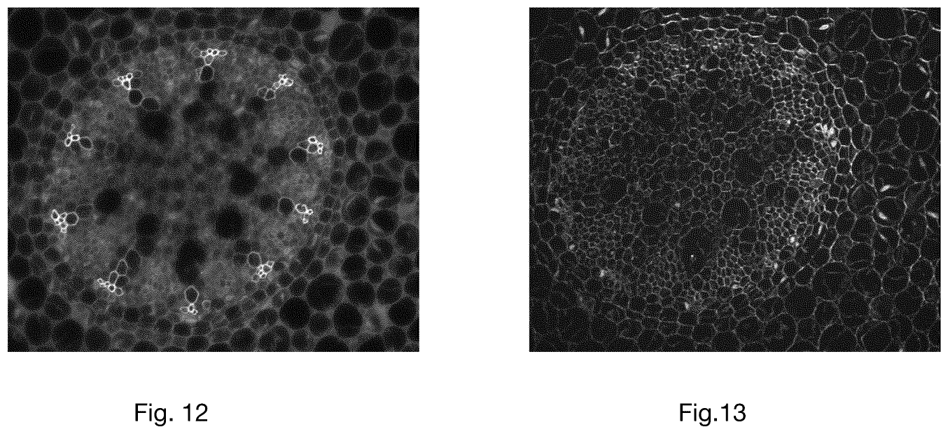

With regard to the aforementioned filter actor, FIGS. 12 and 13 show example images image of a Convallaria majalis in different imaging modes which can be implemented by inserting and removing an emission filter. More specifically, FIG. 12 shows an example image that has been obtained with an emission filter inserted into the detection beam path 114. In contrast, FIG. 13 shows an example image that has been obtained with an emission filter removed from the detection beam path 114.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 fluorescence microscope
102 illumination device
104 excitation beam path
106 sample
108 sample carrier
110 light source
112 detection device
114 detection beam path
116 objective
118 lens system
120 emission filter
122 tube lens
124 light detector
126 light guiding system
128 beam shaping unit
130 deflection mirror
132 deflection mirror
134 deflection mirror
136 deflection mirror
138 light channel
140 back focal plane
142 filter actuator
145 exit pupil of beam expanding system
202 beam expanding system
400 fluorescence microscope
412 detection device
420a emission filter
420b emission filter
440c emission filter
422a tube lens
422b tube lens
422c tube lens
424a light detector
424b light detector
424c light detector
442 multispectral detector system
444a color channel
444b color channel
444c color channel
446 spectral beam splitter
448 spectral beam splitter
528 beam shaping unit
530 collimator lens
532 annular stop
534 outer marginal ray
536 inner marginal ray
628 beam shaping unit
650 beam expanding system
652 lens
728 beam shaping unit
750, 850 beam expanding system
752 conical mirror
754 conical mirror
828 beam shaping unit
852 axicon lens
854 axicon lens
928 beam shaping unit
954 diffusing disk
1028 beam shaping unit
1052 axicon
1054 axicon
1056 lens
1058 lens
SE support for excitation
SD support for detection

1. A microscope for fluorescence light imaging, comprising:
an illumination device configured to direct excitation light along an excitation beam path into a sample, and
a detection device configured to detect fluorescence light emanating from the sample along a detection beam path which is located in a same hemisphere relative to the sample as the excitation beam path,
wherein the illumination device comprises a light guiding system configured to guide the excitation light such that, in phase space defined by position and angle of a light beam, a support of the excitation beam path is disjunct from a support of the detection beam path, and
wherein the detection device comprises at least one emission filter configured to allow the fluorescence light propagating along the detection beam path to be detected for fluorescence light imaging while discarding light that is spectrally different from the fluorescence light.

2. The microscope according to claim 1, wherein the angle between the excitation beam path and the normal of the plane of detection is less than 87°

3. The microscope according to claim 1, wherein the light guiding system comprises a reflective assembly configured to reflect the excitation light onto the sample.

4. The microscope according to claim 1, wherein the detection device comprises an objective including a lens system configured to collect the fluorescence light from the sample, and
wherein the light guiding system is configured to guide the excitation light past the lens system of the objective onto the sample.

5. The microscope according to claim 4, wherein the objective is formed by a dark-field objective which includes a light channel being part of the light guiding system and configured to guide the excitation light past the lens system onto the sample.

6. The microscope according to claim 1, wherein the detection device comprises a multispectral detector system configured to perform multispectral fluorescence light imaging.

7. The microscope according to claim 6, wherein the multispectral detector system comprises a plurality of light detectors, each light detector being configured to detect one of a plurality of different spectral components of the fluorescence light.

8. The microscope according to claim 7, wherein the detection device comprises a plurality of spectral beam splitters, each beam splitter being configured to direct at least one of the different spectral components of the fluorescence light to an associated one of the light detectors.

9. The microscope according to claim 1, wherein the excitation beam path is free of a dichroic beam splitter for separating the fluorescence light from the excitation light.

10. The microscope according to claim 1, wherein the at least one emission filter is configured to be selectively inserted into and removed from the detection beam path.

11. The microscope according to claim 1, wherein the light guiding system comprises a beam shaping unit configured to shape the excitation light into an annular light distribution around an optical axis of the detection device.

12. The microscope according to claim 11, wherein the beam shaping unit comprises a collimator lens configured to collimate the excitation light emitted from a light source, and an annular stop configured to confine the excitation light to the annular light distribution.

13. The microscope according to claim 12, wherein the beam shaping unit comprises a beam expanding system which is located between the collimator lens and the annular stop, the beam expanding system being configured to form a conically divergent light distribution from the collimated excitation light.

14. The microscope according to claim 13, wherein the beam expanding system comprises two axicon lenses and a relay optical system, wherein the relay optical system is configured to image an exit pupil of the illumination light after the second axicon onto the annular stop.

15. The microscope according to claim 11, wherein the beam shaping unit contains at least one of an axicon lens, a cone shaped mirror, a diffractive optical element, a spatial light modulator, or a digital mirror device.

16. A method for fluorescence light imaging of a sample, the method comprising:
directing excitation light along an excitation beam path into the sample, and
detecting fluorescence light emanating from the sample along a detection beam path which is located in a same hemisphere relative to the sample as the excitation beam path,
wherein the excitation light is guided such that, in phase space defined by position and angle of a light beam, a support of the excitation beam path is disjunct from a support of the detection beam path, and
wherein at least one emission filter is used to allow the fluorescence light propagating along the detection beam path to be detected for fluorescence light imaging while discarding light that is spectrally different from the fluorescence light.

17. The method according to claim 16, wherein a plurality of different spectral components of the fluorescence light emanating from spectrally distinct fluorescent labels are detected using a multispectral detector system, and
wherein abundances of the spectrally distinct fluorescent labels are determined based on spectral unmixing of the different spectral components.
